(19) United States
(12) Patent Application Publication
(10) Pub. No.: US 2008/0088704 A1
(43) Pub. Date: Apr. 17, 2008

(54) Method of making digital planimetry measurements on digital photographs

(76) Inventors: Martin Edmund Wendelken, Elmwood Park, NJ (US); Ronald Arpino, Bradford, CT (US)

Correspondence Address: Martin E. Wendelken, 610 Boulevard, Elmwood Park, NJ, 07407, US

(21) Appl. No.: 11/974,596

(22) Filed: Oct. 15, 2007

Related U.S. Application Data
(60) Provisional application No. 60/851,552, filed on Oct. 13, 2006.

(51) Int. Cl. H04N 17/00

(52) U.S. Cl. 348/188; 348/E17.002

(57) ABSTRACT

A novel method of calibrating digital photographs providing accurate planimetry measurements of objects within digital image 12 is disclosed herein. Digital image 12 is imported into a computer program where a calibration method is performed using calibration line 20 that is dragged and dropped to ruler 10 in digital image 12. The novel method provides users with a method to perform a number of accurate planimetry measurements including linear measurements 44 & 46, total surface area 24 along with sub area measurements 50, 52, 54, 56, and circumferential 66 measurements. In addition volume 42 measurement can be calculated and associated with various area parameters 50, 52, 54, 56, when various depth parameters 58, 60, 62, 64 are provided.

### 1. FIELD OF THE INVENTION

This patent relates to a method of making digital planimetry measurements on digital photographs or regular photographs digitally scanned into a computer.

### 2. BRIEF DESCRIPTION OF PRIOR ART AND BACKGROUND OF THE INVENTION

Digital photographs are used to capture images of objects, persons, places, and things. Digital photographs are use to record a moment in time. Some examples are in medicine (human & veterinary), images are taken of wounds and skin lesions. Such pictures are used to monitor changes in the pathological condition which can provide clues as to if a patient's wound is getting better or worse. Digital images can also be used to determine if specific medications or treatment regimens are helping to increase healing rates. Police, scientists, and research investigators take photographs of auto accidents, crime scenes, and various experiment results. These digital images provide visual records that may be studied in detail providing clues to the cause and result of an accident, or to provide a record that can show changes in subject matter during experiments. Currently, there is a need to have accurate measurements made of objects within digital photographs. Present art is costly, complex, and time consuming. Perform and obtain measurements often involves multiple cameras and expensive equipment.

### Example of Current Need

Physicians, nurses, and other health care workers are presently measuring chronic wounds directly on patients by using a straight ruler. Wound area is calculated by multiplying length×width. This has produced area measurements with 20% or more error due to wounds having irregular shapes. Still others health care professionals are making measurements by tracing a wound using a pen on clear acetate sheets. The surface area of the wound is determined by placing the acetate sheet with the tracing over a grid with a number of squares (i.e. 1 centimeter squares) and counting the number of squares within the tracing. It has been well documented that tracings made on patients also are subject to large error due to the inconsistent way that tracings are performed. Further, direct contact of the wound produces steam below the surface of the acetate sheet blocking the view of the wound during tracing. Even more important, touching a wound increases the risk of transferring germs between parties in addition to causing pain for a patient. An accurate, non-contact, and easy to use digital photo planimetry method has a number of advantages of current art.

A number of attempts have been made to help measure wounds on photographs. One is U.S. Pat. No. 5,967,979 October, 1999 by Taylor et al. This patent describes a method of measuring wound by including a target plate. Taylor determines the coordinates of vanishing points and parallel lines on the target object. Taylor then uses the same coordinate transformations applied to an adjacent wound, which allows for measurements. There are other equally complex variations that use multiple pictures viewed a various known angles to determine measurements. In the disclosed U.S. Pat. No. 5,396,331 by Kitoh et al., two or more CCD cameras are use to capture images at various angles. Measurement calculated based on distance and angles obtained. The multiple views are used to help discover the distance between the camera and subject or by taking pictures at known distances from the subject. These methods provide scenarios where mathematical ratios are used to determine measurements. Still other methods project a grid on the subject and then acquire a picture. This is disclosed in U.S. Pat. No. 4,535,782, Zoltan August, 1985. The grid is used to determine the surface area and a volume. The method requires a reference volume located near the volume to be determined. Still other attempts to help determine measurement from a photograph we disclosed by Flaton in April, 1988 in U.S. Pat. No. 4,736,739. Flaton uses a photographic specimen mat with a grid of know sizes used to determine measurements. In U.S. Pat. No. 5,957,837, Raab disclosed a complex wound management system that includes a complex coordinate measurement machine that collects wound size and other related data. This disclosed invention relates to a novel method that allows a person to take a picture of a wound or subject matter without regard to distance. The image is taken with a simple linear ruler in the picture, usually placed adjacent to object needing the measurement. The photographer to insure that the picture is captured properly instantly reviews the image on the screen on the digital camera. An acceptable picture is then downloaded to a computer or the camera may be part of the computer system were the image is stored. The image is calibrated for measurement using a digital planimetry computer program (PictZar® CDM, BioVisual Technologies, N.J.) on the computer. This same program provides linear, circumferential, surface areas, and volume measurements. All data is embedded into the picture and save in reports that are generated by the program.

Although this disclosure depicts a use of the invention involved with a medical application, this invention may be used for the measurement of any object when taking pictures with a digital camera. An example is taking a picture of a wall with a ruler in the picture to determine the surface are of the wall or any fixture that might be attached to the wall. Further, images taken with a regular camera may take advantage of this novel disclosure. Such images can be measured providing a ruler is within the image taken. A regular photograph may then be digitally scanned into a computer where the disclosed method of calibration provides accurate measurements. The disclosed method only requires that a ruler be captured within the picture along with the object or objects to be measured. A wall with a ruler, automobile with a ruler, tree with a ruler or any object, which a photographer captures, can have accurate planimetry measurements performed.

### 3. OBJECTIVES AND ADVANTAGES

The present invention provides an easy to use and simple method of making measurements on digital photograph.

A principal objective of this invention is to allow clinicians and others to record the size and surface areas of objects within digital photographs.

Another objective of this invention is to allow anyone who currently owns a digital camera to take pictures and use this invention to make measurements on the images on their current computer.

Still another objective of this invention to have simple a two-click calibration sequence on a linear ruler with the digital photograph.

Yet another objective of this invention is to eliminate the need for multiple cameras to be use to determine planimetry measurements on photographs.

Another objective of this invention is to provide multiple area measurements to be made in a single digital image.

Still another objective to allow the photographer obtain digital images of objects and make measurements on the image without regard to the distance between the camera and the object.

Yet another objective of this invention is to provide volume calculation based on images acquired by images from a digital camera.

Another objective of this invention is to allow the measurement of wound areas regardless of shape.
The above and other objectives of this invention may be more clearly seen when viewed in conjunction with the accompanying drawings wherein.

### 4. BRIEF DESCRIPTION OF DRAWINGS

FIG. 1 is an image of a clinician tracing a wound on clear acetate film.

FIG. 2 is an image of a clinician obtaining a digital image of a wound using a computer with a built in camera.

FIGS. 3a-b show the two-point calibration of digital image using a simple ruler within the image.

FIGS. 4a-b reveals the controls to select the measurement parameter and two linear measurements made on a digital photograph.

FIGS. 5a-e exhibits a display for the results of area measurements made by a clinician and the sequence of filling the surface of the wound with color to determine surface area.

FIG. 6a-e reveals images of a wound with multiple surface measurements and the percentages of each measurement that make up that wound.

FIG. 7a-e disclosed a method of assigning depth values to a number of surface areas to determine a volume measure.

FIG. 8a-c show a circumferential measurement made on a digital photograph and the data imbedded into the digital image.

### 5. REFERENCE TO NUMERALS IN FIGURES

| | | | |
|---|---|---|---|
| 2 | Clear acetate film | 4 | Subject |
| 6 | Pen or Marker | 8 | Wound |
| 10 | Ruler | 12 | Digital Image |
| 14 | Photographer, Clinician | 16 | Digital Camera |
| 18 | PictZar ® Planimetry | 20 | Calibration Line |
| | Program | | |
| 22 | Calibration Button | 24 | Total area Button & Data Result |
| 26 | Length Button & Data Result | 28 | Width Button & Data Result |
| 30 | Circumference Button & | 32 | Depth Button & Data |
| | Data Result | | Result |
| 34 | Blue area value & percentage | 36 | Red area value & percentage |
| 38 | Green area value & | 40 | Yellow Area value & |
| | percentage | | percentage |
| 42 | Volume Data Result | 44 | Length Line |
| 46 | Width Line | 48 | Area Control Panel |
| 50 | Transparent Area 1 color | 52 | Transparent Area 2 color |
| 54 | Transparent Area 3 color | 56 | Transparent Area 4 color |
| 58 | Depth 1 | 60 | Depth 2 |
| 62 | Depth 3 | 64 | Depth 4 |
| 66 | Circumference Line | 68 | Imbedded Data on Image |

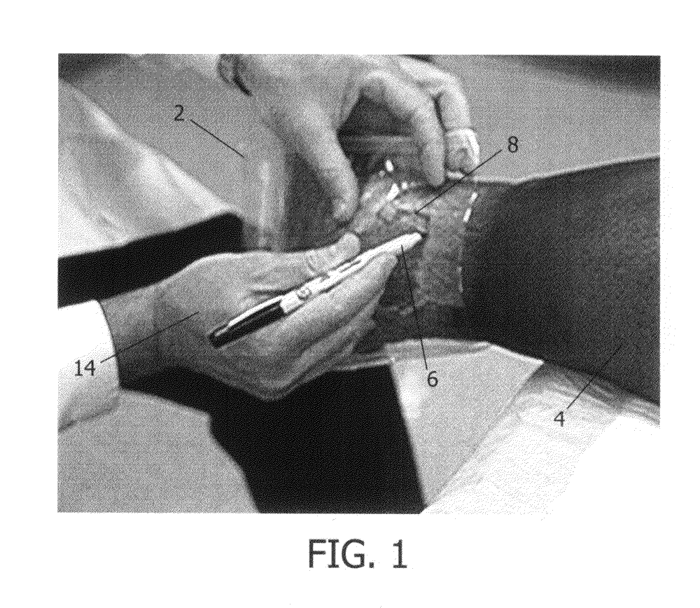

### 6. OVERALL DESCRIPTION OF EMBODIMENT—FIGS. 1-8

In the treatment of chronic wounds, it is important monitor changes in wound 8 size. Such changes provide objective feedback to a clinician 14 that is treating a chronic wound 8. Treatment regimens can change based on changes in wound 8 size and appearance. Digital photographs 12 are becoming more important in the documentation and monitoring of chronic wounds 8. Currently, wounds 8 and other lesions are measured mostly by using a ruler. The length and with of a wound 8 provide crude area measurements. Depending on the shape of the wound, the area can be off 20 to over 100% error because length×width is based on a rectangle. Tracing wounds as seen in FIG. 1 provides better measurements, however there are problems with this method. It is well documented in wound literature journals that no two persons can trace a wound 8 and end up with the same area result. Also it is painful to the patient in addition to being a source of contamination to both the clinician and the patient.

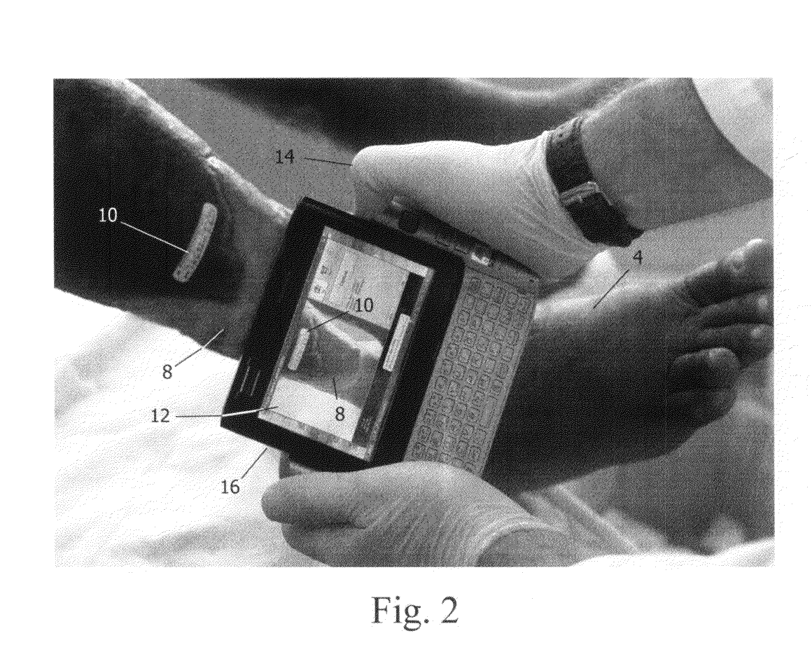

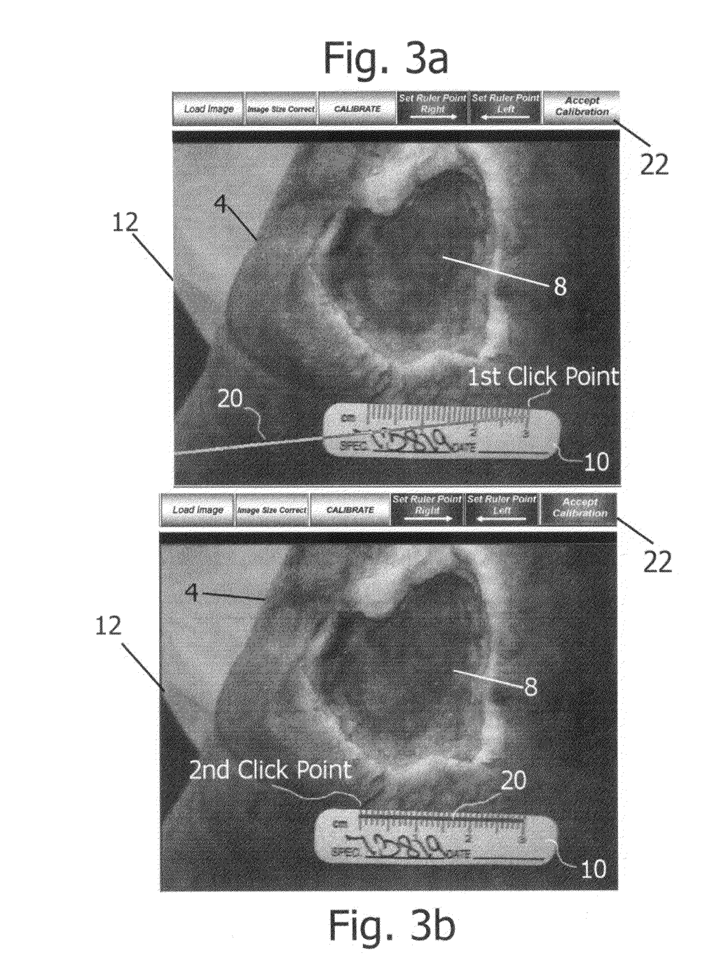

The current invention provides a simple accurate method of making measurements on digital photographs 12. FIG. 2 is a sample of a digital camera 16 that is used to take a picture of a chronic wound 8. A ruler 10 is take along with the object to be measured, in this case wound 8. The digital picture 12 is taken without regard to distance and in general the closer the better. The digital planimetry program 18 provides a method of calibration that will compensate for the distance parameter. FIG. 3a-b shows that two-clicks of a mouse on each end of the ruler 10 in the digital image 12 provides a simple method of calibration.

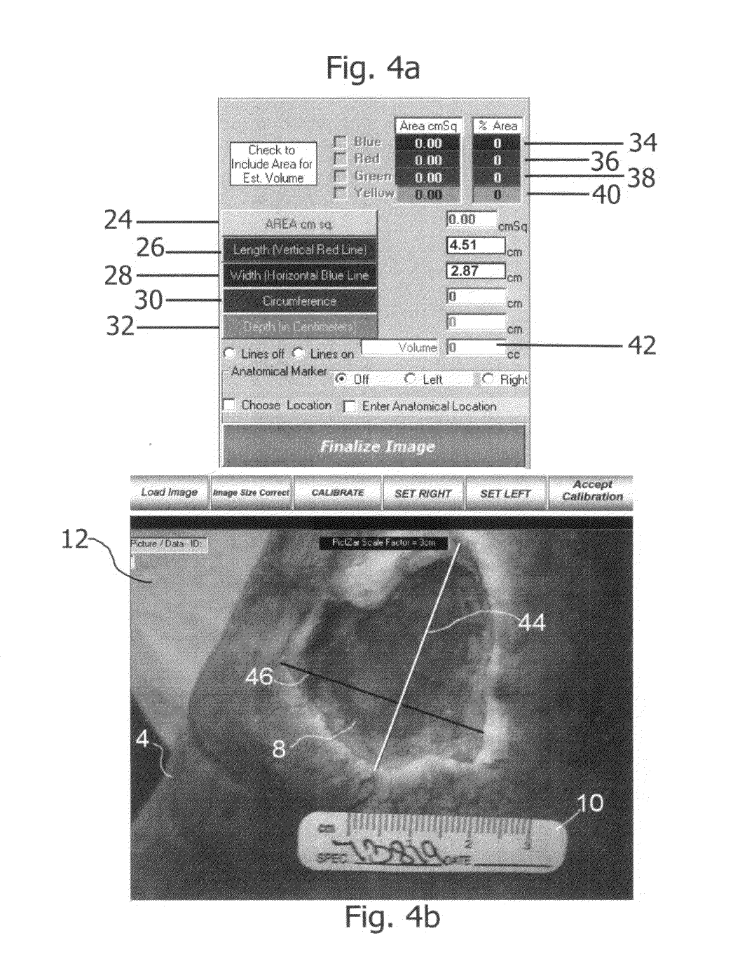

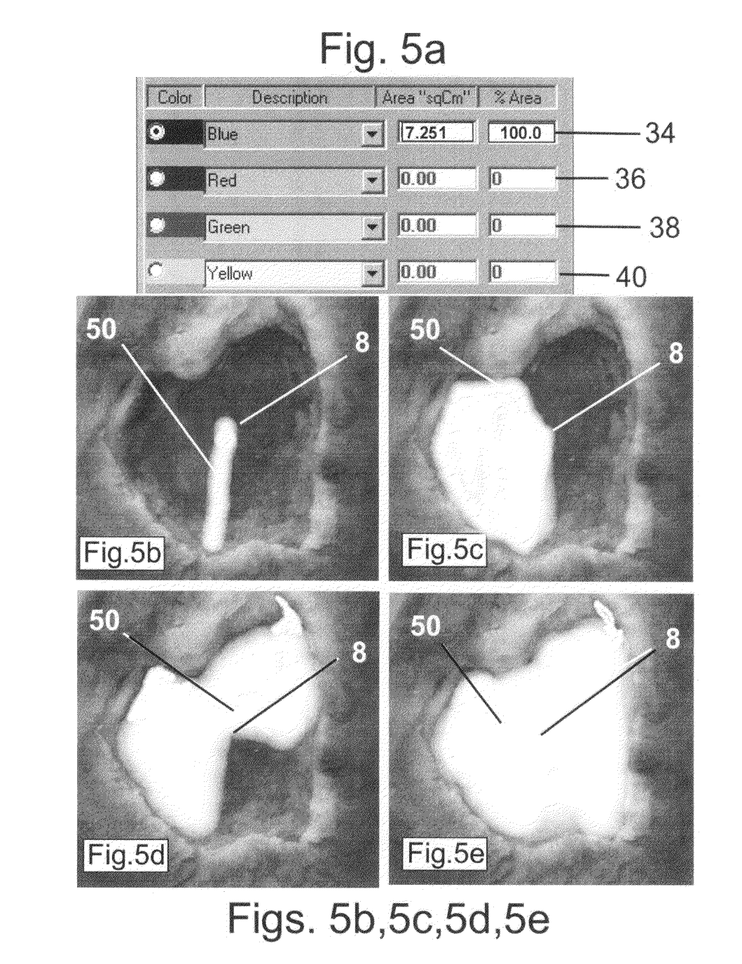

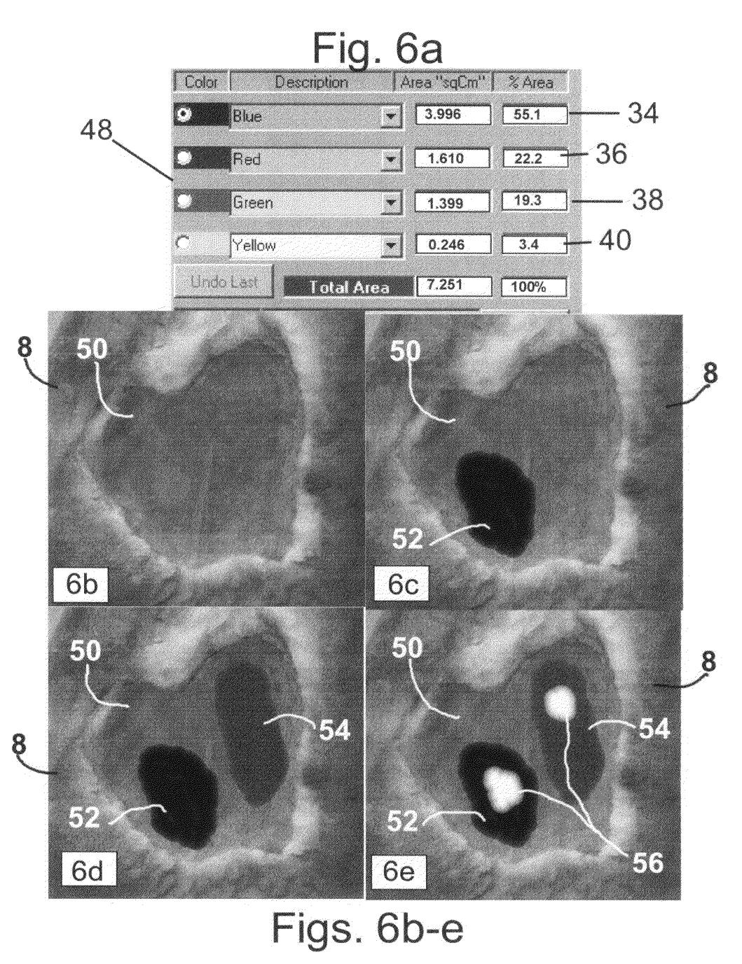

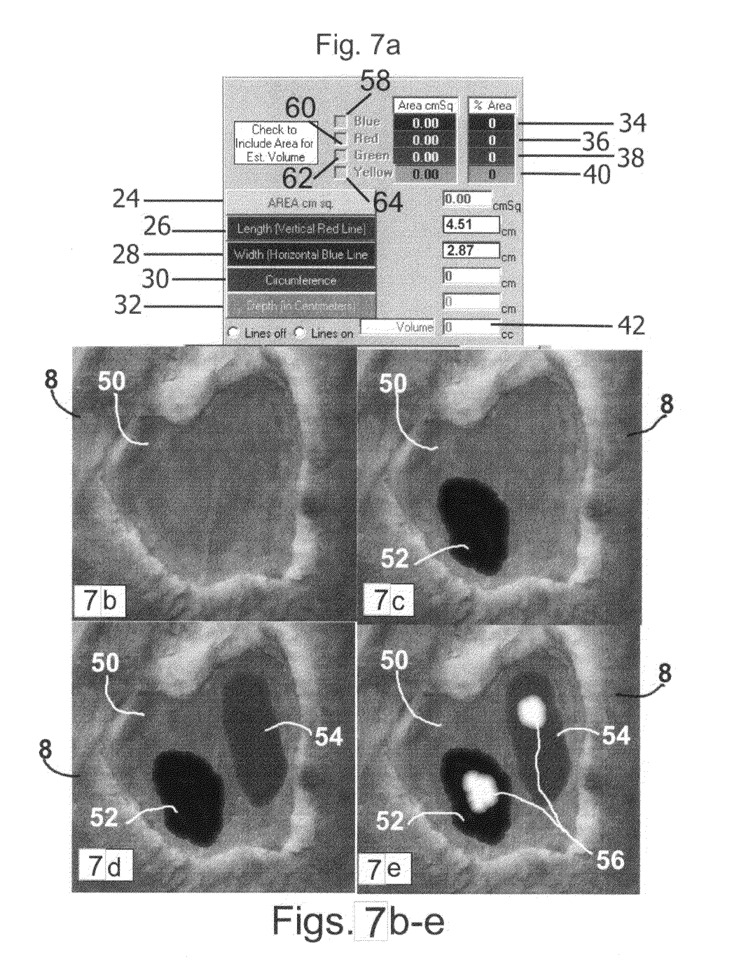

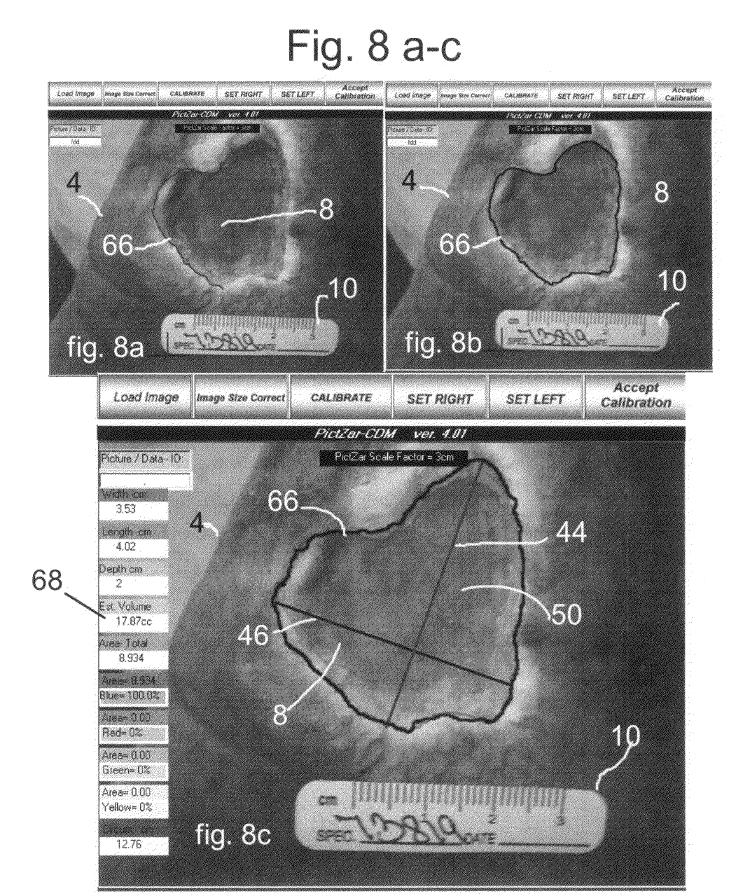

Digital image 12 now calibrated can have a number accurate measurements made on wound 8. FIG. 4a-b shows linear measurements length 44 and width 46 are made by clicking with a mouse on one boarder of wound 8 and dragging the line to the opposite boarder of wound 8. Surface area 50 on wound 8 is then shown in FIG. 5a-e. Any shape wound 8 can be filled in. Digital planimetry program 18 is not based on circumference or points along a circumference. Independent areas 50 can be measured (not contiguous). Multiple areas 50, 52, 54, 56 as seen in FIGS. 6b-e can also be measured. Digital planimetry program 18 allow the clinician to add areas on top of other areas. Digital planimetry program 18 calculates total area 24 and all sub areas 50, 52, 54, 56 along with calculating the percentages of each. This provides clinician 12 with information on the changes with in wound 8 by tissue type. (examples are increase or decreases of muscle, necrotic tissue, exposed tendon or boney areas within a wound 8). FIGS. 7a-e illustrate how digital planimetry program 18 provides a method to allow multiple depth measurements 58, 60, 62, 64 to be entered to provide accurate volume 42 measurements. In FIG. 8a-c digital planimetry program provides circumferential measurements 66 and imbeds all the data into the digital picture 12.

### 7. OPERATION OF THE INVENTION FIGS. 1-2-3-4-5-6-7-8

FIG. 1 is an example of a clinician 14 making a manual tracing (currently the a common method used to determine surface area) of wound 8 on subject 4 using clear acetate film 2. A pen or marker 6 is used to trace wound's 8 margin. Acetate film 2 is placed over a grid of known size, (i.e. 1 centimeter squares) whereby clinician 14 counts the squares within the acetate film 2 tracing to determine wound 8 surface area. This is time consuming and studies have shown that two people tracing the same wound have different results.

FIG. 2 depicts clinician 14 taking digital image 12 of wound 8. Clinician 14 places ruler 10 on subject 4 adjacent to wound 8 margin. Digital camera 16 or a computer with digital camera 16 incorporated (as depicted) is used to capture image 12. Image 12 is obtained by aiming camera 16 with its lens pointing directly over wound 8. Wound 8 surface is perpendicular to the to direction of camera 16 lens. Image 12 is taken without regard to distance, that being as close to or as far from subject 4 as clinician 14 deems proper. Clinician 14 after reviewing image 12 then downloads image 12 into a computer having photo digital planimetry program 18 installed.

FIGS. 3a-b shows image 12 loaded into photo planimetry software program 18. Calibration of image 12 is preformed by dragging and dropping calibration line 20 to ruler 10 within image 12. In this example a 3-cm scale is the default scale chosen.
With a computer mouse, a clinician 14 clicks the far end of ruler 10 (set point right FIG. 3a) at the 3 centimeter mark in image 12, (1^{st} click point). One end of calibration line 20 automatically moves to the 1^{st} click point on ruler 10, in this case the 3 cm mark on ruler 10. Using the computer mouse (FIG. 3b) a second time, clinician 14 now clicks the 0 cm mark on ruler 10 within image 12, (2^{nd} click point). The opposite end of calibration line 20 is automatically set at the 0 cm point on ruler 10.
The clinician 14 then accepts line 20 placement on ruler 10 by clicking on accept calibration button 22 in planimetry program 18. Calibration line 20 is now 3 cm long. Image 12 is now ready to have measurements made of wound 8 .

FIG. 4 Measurements of wound 8 are now made directly on image 12. This may be accomplished by using a number of interfaces such as a computer mouse, Tablet PC with pen, touch screen monitor, and USB tablet with pen. Linear measurements are made by choosing a parameter (ie. Length button 24 or width button 26). The user then makes exact linear measurements by choosing length measurement button 24. Once invoked, clinician 14 can generate a Length Line 44 by clicking on one margin of wound 8 and dragging line 24 to the opposite margin of wound 8. A width measurement is performed the same way by choosing Width Button 26 which then invokes another line of a different color. Clinician 14 then will click on one margin of wound 8 and dragging line 46 to the opposite margin of wound 8. The width line 46 crosses perpendicular to length line 44. The results are instantly displayed (4.51 cm and 2.87 cm) in text boxes next to length button 26 and width button 28.
FIG. 5a-c Area measurements can performed by first choosing the area button 24 (FIG. 4a) to invoke this measurement. To determine surface area, clinician 14 begins by clicking on the center of wound 8 in image 12 with a mouse. While holding the left mouse button down the user moves the cursor to the margin of the wound (see FIG. 5b) where the initial area 50 solid color fills the wound surface as the cursor move over the image. The clinician 14 (still holding mouse button down) then follow wound 8 margin using the mouse which fills wound 8 with a solid transparent color 50 (FIG. 5c about 50% filled with color 50, then FIG. 5d 75% filled, lastly FIG. 5e is 100% filled with color 50. Surface area of wound 8 is atomically displayed in blue area value text box 34 in centimeters squared (See FIG. 5a). The computer planimetry program 18 compiles area measurements in sq cm automatically.

Directing attention to FIG. 6a-e. The planimetry program 18 has the ability to perform multiple surface areas. In FIG. 6b the entire surface area of wound 8 was determined as explained in FIG. 5b-e. Additional areas can be made and calculated by choosing a second color and painting directly on top of this first color 50. FIGS. 6c-6e, shows that sequence. FIG. 6c shows that clinician 14 added additional area color 52. In FIG. 6d a third color area 54 is added. Lastly in FIG. 6e a two separate additional areas 56 same color is added. The ability of using different solid areas 50, 52,54,56, provides a clinician to the ability distinguish the surface area and percentage of different tissue types that comprise a wound or any surface. The program 18 then calculates the area of each of the tissue types and percent of each tissue type that make up the wound 8 with the results being displayed in FIG. 6a. Still further, planimetry program 18 provides for areas of normal tissue may be within wound 8 by allowing for removal of colored area 50, 52, 54, 56 by erasing the specific sections from that tissue. This produces normal islands that are not calculated as wound 8 surface area providing very accurate measurements.

FIG. 7a-e. Another useful measurement provided by planimetry program 18 is a volume measurement 42. The depth of a wound is commonly determined by placing a sterile probe or cotton tipped applicator within the wound. This same probe may have a ruler incorporate or the probe may then be held next to a ruler where the depth measurement is determined. If the depth of wound 8 is know or obtained by means of an external measurement, (i.e. a cotton tip measurement stick), clicking depth measurement button 32 activates and provide a way to entered a depth measurement. Wound 8 volume 42 will be calculated base on 1 or more solid areas 50, 52, 54, or 56. FIG. 7a shows check boxes to associate depth measurements with a particular surface area, Depth-1 58, Depth-2 60, Depth-3 62, and Depth-4 64. An accurate volume may be determined by calculating the surface area×depth measurement of wound 8 along with the percentage that it comprises of the total wound 8 surface area 24. Computer program 18 gives an accurate wound 8 volume 42 using these parameters.
Directing attention to FIGS. 8a-c. A circumference measurement may be performed by clicking on circumference button 30 (FIG. 4a) which activates this function. Clinician 14 begins by moving the computer cursor to wound 8 margin. While holding a computer mouse button down, on the margin of wound 8, the user traces the entire margin of wound 8 FIGS. 8a & 8b. The circumference is instantly displayed in the text box next to circumference button 30 (FIG. 4a) after returning to the starting point and releasing the mouse button. Once all necessary measurements on digital image 12 have been made by clinician 14, planimetry program 18 imbeds the data 68 into digital image 12. (See FIG. 8c).

### 8. SUMMARY AND SCOPE

After reading the above disclosure, it becomes apparent that digital planimetry program 18 provides a simple non-contact method of measuring wounds 8 and other objects within a digital photograph 12. This novel method of calibration on ruler 10 allows current owners of digital cameras 16 to take digital pictures 12 of wounds 8. These same owners can then download digital images 12 obtained to their current computers. Digital images 12 with the planimetry measurements perform by digital planimetry program 18 provides a system to monitor and archive measurements.
A summary of measurements derived from a single calibration made by dropping line 20 on ruler 10, which was acquired when taking image 12 with digital camera 16 are as follows.
Linear Measurements: Length 46 & Width 48
Area Measurement Available:
Area 1 & Percent of Area-1 34
Area 2 & Percent of Area-2 36
Area 3 & Percent of Area-3 38
Area 4 & Percent of Area-4 40
Total Area 24
Circumference 66
Single Volume (with one depth 58 added)
Single Volume (with multiple depth measurement added 58, 60, 62, 64.

This invention offers a number of additional benefits to users of the invention including:

A simple calibration method on digital photographs 12.

A no-touch method to measure painful wounds 8.

Planimetry measurements can be made on any shape wound 8.

Multiple area planimetry measurements on a single image 12.

Digital photographs 12 are taken with any digital camera 16 without regard to distance.

The ability to determine a wound 8 composition by tissue type and percentage of each.

A method of performing volume measurements 42 based on numerous areas of different depth 58, 60, 62, 64.
The central concept of providing accurate, easy to use digital planimetry measurement on digital photograph may be achieved by several varying methods without deviation from the intent of this invention.

While the invention has been explained by a detailed description of certain specific embodiments, it is understood that various modifications and substitutions can be made in any of them within the scope of the appended claims that are intended also to include equivalents of such embodiments.

Having described our invention what is claimed is:

1. A method of calibrating a digital photograph for making digital planimetry measurements comprising:
a digital image of an object taken with a digital camera;
said digital image also contains a ruler;
said digital image is download to a computer and wherein;
said ruler is utilized to calibrate said digital image providing a numeric scale for calculating planimetry measurements on said digital image.

2. A method of calibrating a digital photograph for making digital planimetry measurements in accordance with claim 1 wherein;
a computer program provides a calibration line that is dragged and dropped to the ruler within the digital image.

3. A method of making digital planimetry measurements on calibrated digital photographs in accordance with claim 2 wherein:
the calibrated digital image has objects to be measured and the computer program provides a means to draw linear measurements on the digital image.

4. A method of making digital planimetry measurements on calibrated digital photographs in accordance with claim 2 wherein:
the calibrated digital image has objects to be measured and the computer program provides a means to paint said objects with a color and then calculates surface area measurements of said objects within the digital image.

5. A method of making digital planimetry measurements on calibrated digital photographs in accordance with claim 2 wherein:
the calibrated digital image has objects to be measured and the computer program provides a means to paint said objects with multiple colors and then calculates surface area measurements and percent surface area of said multiple colors of said objects within the digital image.

6. A method of making digital planimetry measurements on calibrated digital photographs in accordance with claim 2 wherein:
the calibrated digital image has objects to. be measured and the computer program provides a means to draw circumferential measurements on the digital image.

7. A method of determining a volume base on a digital planimetry area measurement comprising:
multiplying a known depth measurement times a digital planimetry area measurement.

8. A method of determining a volume base on multiple digital planimetry area measurements comprising:
multiplying known depth measurements in selected sections within a digital photograph times the respective digital planimetry area measurements of said selected sections within said digital photograph and calculating the percentage of said planimetry area measurements and said known depth measurements to determine an object's volume.
